(19) United States
(12) Patent Application Publication
(10) Pub. No.: US 2005/0016822 A1
(43) Pub. Date: Jan. 27, 2005

(54) Joystick for agricultural tractor including locking mechanism

(76) Inventors: Jeffrey William Mowatt, Essex (GB); Martin Jon Hipsey, Essex (GB); James Colliar, Chicago, IL (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 10/856,969

(22) Filed: May 28, 2004

(30) Foreign Application Priority Data
Jun. 14, 2003 (GB) 03 13 856.7

(51) Int. Cl. H01C 10/10

(52) U.S. Cl. 200/6 A

(57) ABSTRACT

A joystick control is disclosed having a joystick 12 pivotable about orthogonal axes. A locking mechanism 14 is provided to prevent pivotal movement of the joystick 12 and the top surface of the joystick is fashioned to enable the joystick 12 to function as a wrist support when its position locked.

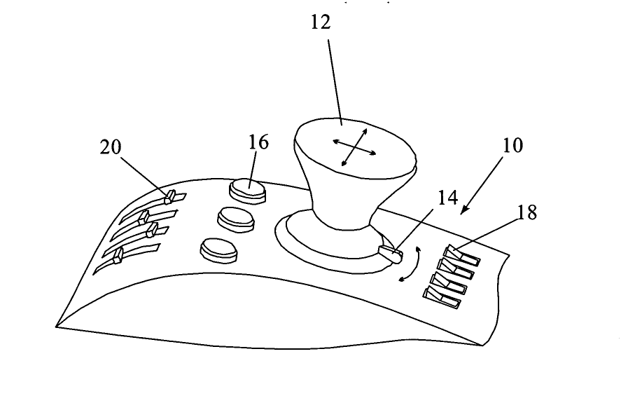

### FIELD OF THE INVENTION

The present invention relates to a joystick control and in particular to one suitable for use in the control panel of an agricultural vehicle.

### BACKGROUND OF THE INVENTION

In the cab of an agricultural vehicle there are numerous controls including those needed to operate ancillary equipment. For some equipment, it is desirable to use a joystick while for others the controls may have the form of ON/OFF toggle switches, push buttons, rotary and linearly slidable control knobs, and so on.

Operating the controls, especially while the vehicle is being driven over rough terrain, can present a problem because the control panel tends to be crowded. While operating a switch, it is possible accidentally to knock a joystick control. Also setting a control that requires fine adjustment when the operator's hand is not being steadied can be difficult to achieve and there is rarely sufficient space on the control panel to accommodate a dedicated wrist support.

### SUMMARY OF THE INVENTION

With a view to mitigating the foregoing problems, the present invention provides a joystick control having a joystick pivotable about orthogonal axes and a locking mechanism to prevent pivotal movement of the joystick, the top surface of the joystick being fashioned to enable the joystick to function as a wrist support when its position locked.

Though the locking mechanism may act only to lock the joystick in a predetermined position, it is preferred for it to be able to lock the joystick in any previously set position.

For increased comfort, it is preferred for the top surface of the joystick to be padded or formed of a soft conformable material.

In a second aspect, the invention provides a control panel comprising a joystick control as set forth above in combination with a plurality of manually operable further controls positioned to be within the reach of a hand resting on the top surface of the joystick.

The further controls may be toggle switches, push buttons, rotary or linearly slidable control knobs.

### BRIEF DESCRIPTION OF THE DRAWINGS

The invention will now be described further, by way of example, with reference to the accompanying drawing, which is a perspective view of part of a control panel of an agricultural vehicle.

### DESCRIPTION OF THE PREFERRED EMBODIMENT

The single FIGURE shows part of a control panel 10 of an agricultural vehicle, such as a tractor. The panel carries several controls for the different items of equipment on the vehicle. Amongst the controls is a joystick 12, push buttons 16, toggle switches 18 and linear potentiometers 20. The function served by the various controls is not of significance to the present invention and will not therefore be described in detail. The controls may for example be for a mechanical digger or the hitch of a plough.

The problem that the vehicle driver has in operating all these controls is that it is easy to knock the joystick 12 when operating one of the other controls, and adjusting the positions of the linear potentiometers 20 is not easy when there is no convenient place for the driver to steady his hand.

To mitigate these problems, the invention provides a locking mechanism which can lock the joystick 12. In the case of the illustrated embodiment, the joystick 12 can be locked in any position by turning the collar surrounding the base of the joystick using the finger grip 14. If the base of the joystick is designed as a ball and socket joint, the action of the collar is to clamp the ball down within its socket enabling the joystick to be locked in any position. It would be alternatively possible to provide a locking pin to lock the joystick in only one predetermined position, but this would render the joystick inoperative when it is locked.

By locking the joystick 12, its position will not be disturbed accidentally when operating one of the other controls, 16, 18 or 20.

A further advantage of locking the joystick is that its top surface can then be used as a wrist rest permitting the driver to steady his hand when operating sensitive controls such as the potentiometers 20. In this context, it is preferred for the top of the joystick to be padded or made of a conformable material such as a rubber or an elastomeric foam.

1. A joystick disposed in a control module and pivotable about orthogonal axes, the joystick comprising a locking mechanism adapted to prevent pivotal movement of the joystick, wherein the top surface of the joystick is fashioned to enable the joystick to function as a wrist support when its position locked.

2. A joystick control according to claim 1, wherein the locking mechanism is operative to lock the joystick in a predetermined position.

3. A joystick control according to claim 1, wherein the locking mechanism is operative to lock the joystick in any preset position.

4. A joystick control according to claim 1, wherein the top surface of the joystick is padded or formed of a soft conformable material.

5. A control panel comprising a joystick and a plurality of manually operable controls positioned to be within the reach of a hand resting on the top surface of the joystick, the joystick comprising a locking mechanism adapted to prevent pivotal movement of the joystick, wherein the top surface of the joystick is fashioned to enable the joystick to function as a wrist support when its position locked.
